(19) United States
(12) Patent Application Publication
(10) Pub. No.: US 2009/0088297 A1
(43) Pub. Date: Apr. 2, 2009

(54) Pressure medium supply unit for a clutch and an automatic transmission

(75) Inventors: Marco Grethel, Buhlertal (DE); Manfred Homm, Buhl-Neusatz (DE); Eric Muller, Kaiserslautern (DE); Martin Staudinger, Ettlingen (DE); Reinhard Stehr, Buhl (DE)

Correspondence Address: ALFRED J MANGELS, 4729 CORNELL ROAD, CINCINNATI, OH, 452412433, US

(73) Assignee: LuK Lamellen und Kupplungsbau Beteiligungs KG, Buhl (DE)

(21) Appl. No.: 12/283,288

(22) Filed: Sep. 9, 2008

Related U.S. Application Data
(63) Continuation of application No. PCT/DE07/00296, filed on Feb. 15, 2007.

(30) Foreign Application Priority Data
Mar. 9, 2006 (DE) 10 2006 011 376.4
Feb. 15, 2007 (DE) PCT/DE2007/000296

(51) Int. Cl. F16D 48/02

(52) U.S. Cl. 477/158

(57) ABSTRACT

A pressure medium supply unit for a hydraulic system of a motor vehicle that includes a clutch requiring a high hydraulic pressure and a low volumetric flow rate of hydraulic fluid for operation, and an automatic transmission requiring a low hydraulic pressure and a high volumetric flow rate of hydraulic fluid for operation. A single hydraulic pump is provided to supply hydraulic fluid to both the clutch and the transmission.

The invention relates to a pressure medium supply unit for a hydraulic system comprising a clutch that requires high pressure and a low volumetric flow rate as well as an automatic transmission which requires low pressure and a high volumetric flow rate.

Two versions can be designated as state of the art. One solution is that one motor supplies the hydraulic power for the automatic transmission and one motor operates the hybrid clutch directly.

A second possible solution consists in a purely hydraulic implementation. A more powerful electric motor operates a large pump for high pressures. This system can supply both high and low volumetric flows at both high and low pressures, but is unfavorable from the perspective of energy, since the system cannot be optimized for a plurality of operating points.

The object of the invention is to enable a vehicle with a conventional automatic transmission to be converted to a hybrid vehicle with the least possible expense and effort. This is achieved according to the invention by supplying the clutch and the automatic transmission from the same pump-and-motor combination. In this way, a separate hydraulic power pack is intended to be made available, which provides the basic supply for the automatic transmission and which can operate the clutch to disconnect the combustion engine.

The solution already described in the existing art is very unfavorable in terms of energy. Disengaging the hybrid clutch, and in particular keeping it disengaged, requires a small volume flow under high pressure. To however supply the automatic transmission a high volume flow at low pressure is necessary.

This contradiction makes it necessary to find a compromise in designing the motor and the pump.

In the course of solving this problem, numerous concepts therefore arose which make it possible to reduce the hydraulic power consumed by the power pack.

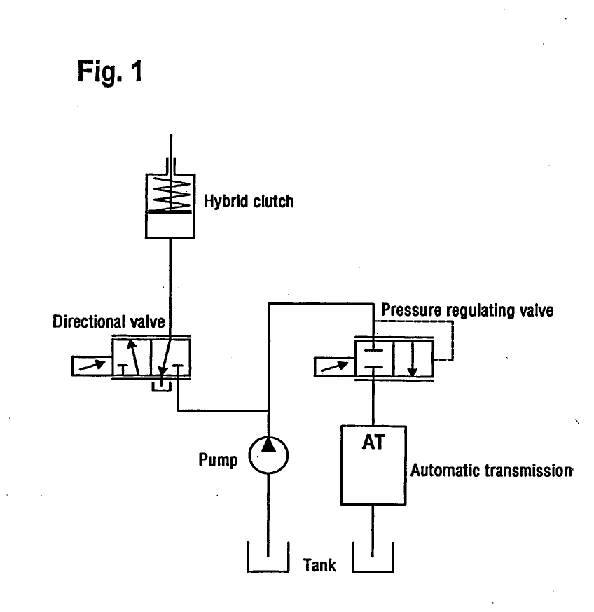

The invention will now be explained in greater detail on the basis of FIGS. 1 through 6.

FIG. 1 comprises the most direct and simplest solution. A pump supplies the automatic transmission through a pressure regulating valve, which sets the pressure so that supply to the hybrid clutch is always ensured. The hybrid clutch is then regulated by means of a directional valve. The entire volume flow of the pump would therefore have to be brought to the operating pressure of the hybrid clutch, although the latter would need merely a static pressure in order to retain its position.

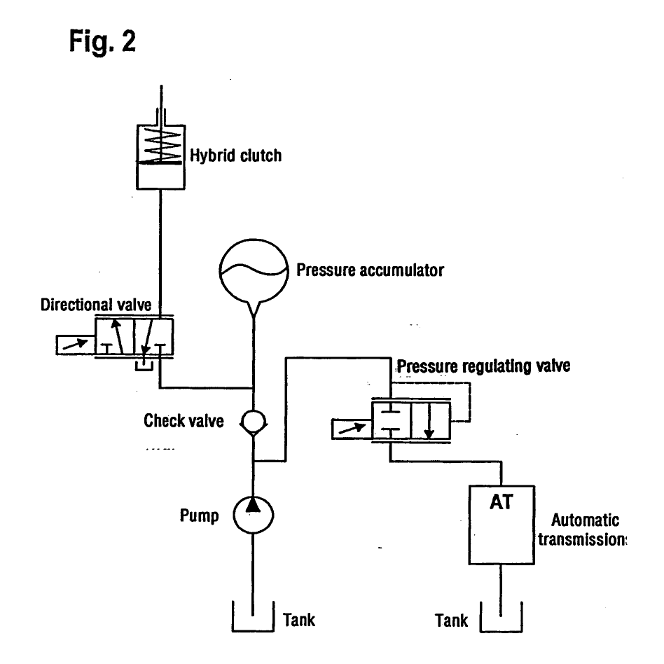

According to FIG. 2, a pressure accumulator is to be used. This results in that the pump must convey high pressure only for a short time, and while the accumulator is full the hybrid clutch is supplied from the latter. Thus until the accumulator is empty again the pump must only work against a low pressure level. This means, however, that in addition to the pressure regulating valve and the directional valve that were already used in FIG. 1, a check valve is also added. Either the pressure regulating valve builds up a pressure that fills the accumulator and operates the hybrid clutch, or the pressure regulating valve is completely opened, so that the volume flow is sent on to the automatic transmission without loss. In the latter case the high pressure part of the system is closed by the check valve, so that the accumulator pressure is maintained.

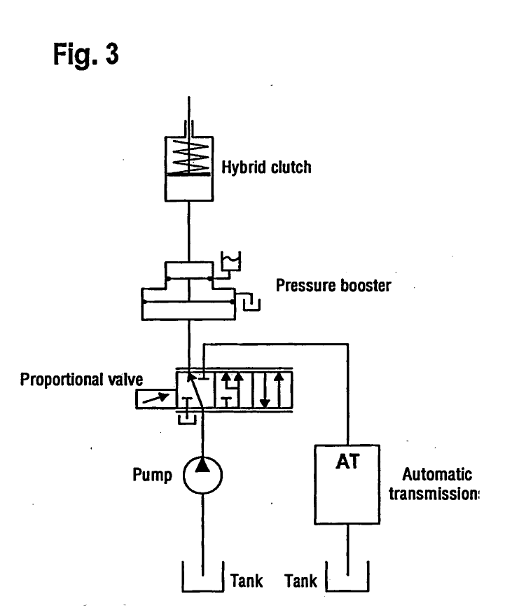

In an embodiment according to FIG. 3, the hybrid clutch is disengaged by means of a pressure booster. A proportional valve divides the volume flow from the pump between automatic transmission and hybrid clutch. The area ratio of the pressure booster is designed so that the average pressure required is at a level similar to that needed by the automatic transmission. In this way the engine and the pump can be designed for an ideal operating point.

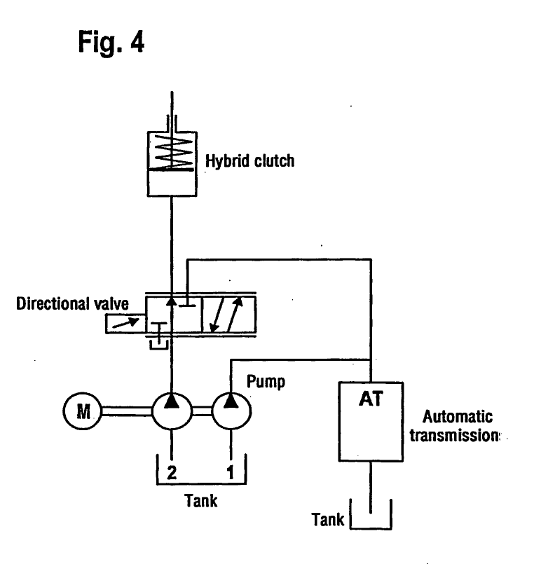

The version according to FIG. 4 utilizes a dual-stream pump. The first stream is designed so that it can cover the basic need of the automatic transmission. The second stream is intended to transport against the high pressure of the hybrid clutch, as long as the latter requires a high volume flow. If the clutch is not supposed to move, then the volume flow of the second stream is rerouted into the circuit of the first stream.

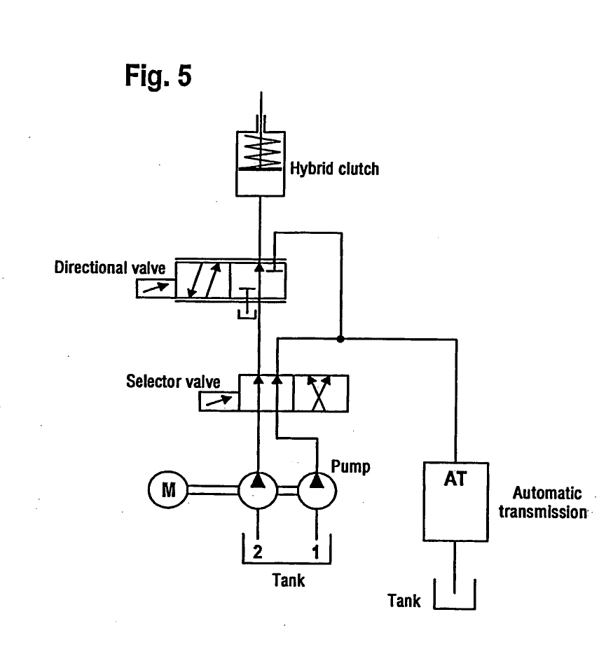

The version according to FIG. 5 also utilizes a dual-stream pump, but the size ratio of the streams is designed differently here. Since no volume flow is needed for the automatic transmission while disengaging the hydraulic clutch, the streams are switched back and forth in such a way that the larger stream operates the part that requires a greater volumetric flow. Compared to the version according to FIG. 4, this makes it possible to prevent the larger stream from having to continuously maintain the pressure of a disengaged hydraulic clutch.

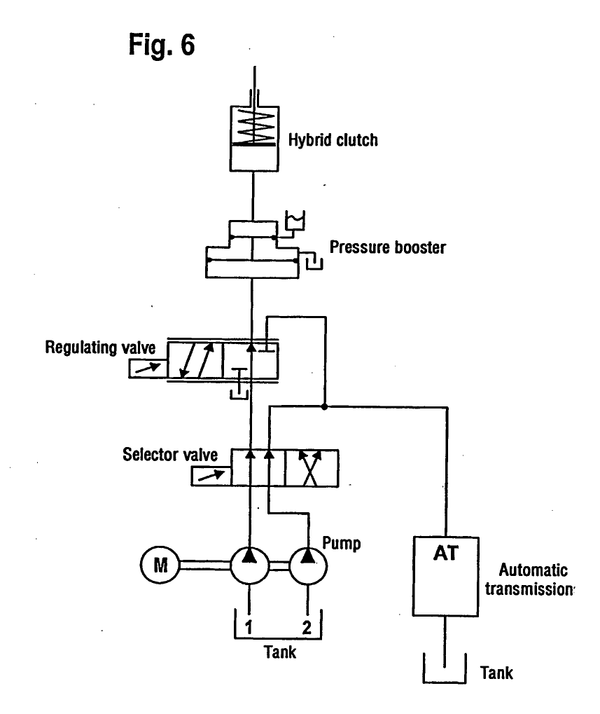

In the version according to FIG. 6, the intent is to combine only the advantages of the plan according to FIG. 3 and the concept according to FIG. 5, in order to further reduce the differences among the various requirements. Optionally, but not explained in greater detail here, the concept according to FIG. 4 can also be combined with the concept according to FIG. 3. This is thus a concept which operates a pressure booster and the automatic transmission by means of a dual-stream pump. Also here, the larger stream is used to cover the volumetric flow requirement that is greater. This is clarified in the sketch. An appropriate design of the pressure boost ratio ensures that the very different requirements of the hybrid clutch and the automatic transmission can be almost completely matched to each other.

1. A pressure medium supply unit for a hydraulic system that includes a hybrid clutch that requires a high hydraulic fluid pressure and a low volumetric flow rate, and an automatic transmission that requires a low hydraulic fluid pressure and a high volumetric flow rate, said supply unit comprising: a unitary pump and motor combination for supplying hydraulic fluid to both the hybrid clutch and the automatic transmission.

2. A pressure medium supply unit in accordance with claim 1, wherein the unit includes a pressure accumulator for supplying the hybrid clutch.

3. A pressure medium supply unit in accordance with claim 2, including a check valve operatively positioned between the pressure accumulator and the pump and motor combination, and between the pressure accumulator and a pressure regulating valve.

4. A pressure medium supply unit in accordance with claim 1, including a pressure booster operatively positioned between the hybrid clutch and the pump and motor combination.

5. A pressure medium supply unit in accordance with claim 4, including a proportional valve operatively positioned between the pressure booster and the pump and motor combination.

6. A pressure medium supply unit for a hydraulic system that includes a hybrid clutch that requires a high hydraulic fluid pressure and a low volumetric flow rate, and an automatic transmission that requires a low hydraulic fluid pressure and a high volumetric flow rate, said supply unit comprising: a dual-stream pump and motor combination for supplying hydraulic fluid to both the hybrid clutch and the automatic transmission.

7. A pressure medium supply unit in accordance with claim 6, including a directional valve operatively positioned between the dual-stream pump and motor combination and the hybrid clutch, and operatively connected between the dual-stream pump and motor combination and the automatic transmission.

8. A pressure medium supply unit in accordance with claim 7, including a pressure booster operatively positioned between the directional valve and the hybrid clutch.
